(19) United States
(12) Patent Application Publication
(10) Pub. No.: US 2025/0116532 A1
(43) Pub. Date: Apr. 10, 2025

(54) Multi-Inertial Measurement Unit (IMU) Combination Unit

(71) Applicant: GM CRUISE HOLDINGS LLC, SAN FRANCISCO, CA (US)

(72) Inventors: Adria Serra Moral, Boston, MA (US); Mayur N. Shah, Pleasanton, CA (US)

(73) Assignee: GM CRUISE HOLDINGS LLC, SAN FRANCISCO, CA (US)

(21) Appl. No.: 18/483,943

(22) Filed: Oct. 10, 2023

(51) Int. Cl. G01C 25/00

(52) U.S. Cl. CPC G01C 25/005

(57) ABSTRACT

Disclosed are embodiments for facilitating a multi-inertial measurement unit (IMU) combination unit. In some aspects, an embodiment includes receiving, at a multi-IMU combination unit (MICU), sensor data from a plurality of inertial data sensors of a same sensor type; for each inertial data sensor, calibrating and transforming the respective sensor data using a calibration estimate for the inertial data sensor, where the calibration estimate is based on pre-integration methods that provide individual kinematic feedback that is compared to fused kinematic feedback from a main filter; combining the calibrated and transformed sensor data from the plurality of inertial data sensors into a fused output for the same sensor type; sampling the fused output to provide a single inertial data measurement for the plurality of inertial data sensors; and providing the fused kinematic feedback for the calibration estimate, the fused kinematic feedback generated from the sampling of the single fused output.

### BACKGROUND

### 1. Technical Field

The disclosure generally relates to the field of processing systems and, more specifically, to a multi-inertial measurement unit (IMU) combination unit.

### 2. Introduction

Autonomous vehicles, also known as self-driving cars, driverless vehicles, and robotic vehicles, may be vehicles that use multiple sensors to sense the environment and move without a human driver. An example autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

### BRIEF DESCRIPTION OF THE DRAWINGS

The various advantages and features of the disclosed technology will become apparent by reference to specific embodiments illustrated in the appended drawings. A person of ordinary skill in the art will understand that these drawings show some examples of the disclosed technology and would not limit the scope of the disclosed technology to these examples. Furthermore, the skilled artisan will appreciate the principles of the disclosed technology as described and explained with additional specificity and detail through the use of the accompanying drawings in which:

FIG. 1 is a block diagram of a detailed view of an example autonomous vehicle (AV) providing a multi-inertial measurement unit (IMU) combination unit (MICU) to combine inertial data measurements from inertial data sensors to provide a single inertial measurement, in accordance with embodiments herein;

FIG. 2 illustrates a computing system of an AV that implements providing a MICU to combine inertial data measurements coming from any number of inertial data sensors to provide a single inertial measurement, in accordance with embodiments herein;

FIG. 3 illustrates an example method implementing a MICU for generating a single inertial measurement for multiple inertial measurement data sensors, in accordance with embodiments herein;

FIG. 4 illustrates an example method implementing a MICU performing polynomial fitting as part of a fusion operation, in accordance with embodiments herein;

FIG. 5 illustrates an example system environment that can be used to facilitate AV dispatch and operations, according to some aspects of the disclosed technology; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Autonomous vehicles (AVs), also known as self-driving cars, driverless vehicles, and robotic vehicles, can be implemented by companies to provide self-driving car services for the public, such as taxi or ride-hailing (e.g., ridesharing) services. The AV can navigate about roadways without a human driver based upon sensor signals output by sensor systems deployed on the AV. AVs may utilize multiple sensors to sense the environment and move without a human driver. An example AV can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

During operation, the AV may depend on geographic and spatial (geospatial) data to localize itself (e.g., obtain its position and orientation (pose)) and other objects within its immediate surroundings, determine routes towards destinations, and to coordinate motor controls to maneuver safely and efficiently while in transit, among other operations. The AV may implement a localization module to perform the localization operations of the AV. The localization module may receive data from one or more inertial data sensors included on the AV. Such inertial data sensors provide the AV with inertial information (e.g., acceleration and angular velocity) and may include inertial measurement units (IMUs), coordinate measuring machines (CMMs), inertial sense modules (ISMs), wheel speed sensors (such as wheel encoders including high-resolution wheel encoders (HRWEs)), and so on. The localization module may listen to the inertial data sensors to receive inertial information. As this inertial information is utilized for localization, the inertial data sensor can be a single point of failure for the AV. As such, the failure may cause a severe degraded state for the AV that can result in an immediate hard stop.

In some cases, the inertial data sensors may be deployed to provide redundancy in the AV system. Furthermore, the inertial data sensors may be deployed as a combination of multiple heterogeneous (i.e., made by different manufacturers and with different specifications) inertial data sensors that may be spatially distributed throughout the AV. Such a configuration of inertial data sensors can make extrinsic and intrinsic calibrations contribute a larger role in performance of the localization module.

There are a number of different approaches for combining inertial data measurements received from multiple inertial data sensors. Three of these approaches include virtual IMU, Augmented Kalman Filter (i.e., adding multiple IMU states in one field (i.e., state augmentation)), and Federated Kalman filter (i.e., running multiple filters in parallel, then aggregating filter estimates).

In a virtual IMU approach, the virtual IMU logic that unifies the n sensor measurements into a single measurement is performed upstream of the main filter that applies a traditional IMU sensor estimator. Hence, the main filter is agnostic to faults of any of the single IMUs (e.g., as long as there is one IMU available, it gets data that it can use to estimate its state). Various fusion methods utilized in virtual IMU can include 1) least squares solve; 2) arithmetic average; and 3) weighted average. As noted, with the virtual IMU approach, the main filter is single-IMU failure agnostic. Virtual IMU is also simple to maintain and easy to implement. However, naive implementations of the virtual IMU approach may suffer from calibration issues. For example, the virtual IMU approach may work well when all of the IMUs are generally time synched. Otherwise, data is averaged at different points in time and systematic errors begin to be added to the main filter. In addition, IMU biases are also virtual and may change drastically as the IMU constellation changes.

In an Augmented Kalman Filter approach, the augmented Kalman Filter adds inertial states to the main estimator filter per each IMU. For instance, for each IMU, the following is estimated:

X_IMU=[global position, global velocity, global orientation, gyro bias, accel bias, extrinsic transform]

Each IMU state is propagated using its IMU data. Then, to inform the filter of the multi-IMU correlations, calibrate each IMU, and gain some localization accuracy, a rigid-body constraint is applied as a measurement update at a given frequency. For example, at 10 Hz, the filter can be informed that the relative position between two global IMU poses should be equal to its extrinsic transform. The Augmented Kalman Filter approach provides for ease of adding new model states and updates. The filter already has multiple similar global kinematics estimates, so marginalizing failed IMUs and swapping to a new one becomes relatively easy. Furthermore, it can both localize and calibrate with the entire IMU constellation.

However, the Augmented Kalman Filter approach generally works well when all IMUs are time synched. Otherwise, when the states are propagated to different times, bookkeeping should be performed to track at which timestamp each state lives, and utilize this information for the rigid-body constraints. Furthermore, the filter can be difficult when dealing with constant memory as IMU states are to be marginalized/added at runtime. In addition, the Augmented Kalman Filter is computationally expensive to run, as there can be multiple states, a few of which are somewhat redundant (e.g., multiple global kinematic estimates at slightly offset points). A concern with the Augmented Kalman Filter approach is timing; dealing with a filter that has blocks of its state living at different points in time can be problematic.

In the Federated Kalman Filter approach, for N IMUs, N local estimator filters are run in parallel, each using its own IMU. Then, the outputs of these N local estimator filters are fused using federate fusion to provide an output solution. As long as one IMU is alive, there is a solution. The Federated Kalman Filter approach is simpler to implement as the exact same local filter runs with just a different input. This can be good for distributed systems where each filter could be running in a different process and, hence, distribute some of the compute workload. However, the Federated Kalman Filter approach has the drawbacks of utilizing duplicates of the filter running. This results in an increased compute workload and additional cross-correlated results (as each filter generally consumes the same global measurement inputs).

Embodiments herein address the above-noted drawbacks of the different approaches for combining inertial data measurements received from multiple inertial data sensors, by providing a multi-IMU combination unit (MICU). The MICU functions run upstream of consumers of inertial measurement data consumers (e.g., a localization module, a perception module, etc.) and can combine inertial data coming from any number of inertial modules to provide a single inertial measurement. The MICU of embodiments herein can simultaneously combine and calibrate any number of inertial data sensors upstream of its consumers, making consumers agnostic of which sensor the data came from in the event of sensor faults or temporary outages, reducing the severity of the degraded state of a single sensor outage. The MICU of embodiments herein is capable of correcting for sensor biases, sensor mounting errors, and time-sync offsets between sensors and is easily extendable to combine as many inertial sensors as we decide to use. As a result, consumers can be inertial data sensor failure agnostic as all combinatorial and estimator logic is encapsulated in MICU. Furthermore, in embodiments herein, the MICU can receive feedback kinematics to calibrate each of the inertial data sensors that are in the MICU constellation. As such, the MICU of embodiments herein can calibrate both the biases as well as the extrinsic calibration, addressing the noted drawbacks of the other approaches discussed above.

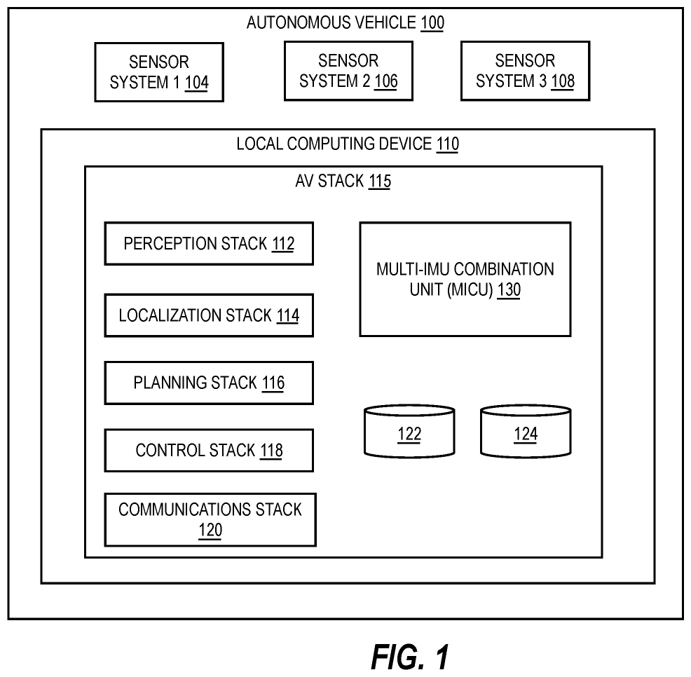

Although some embodiments herein are described as operating in an AV, other embodiments may be implemented in an environment that is not an AV, such as, for example, other types of vehicles (human operated, driver-assisted vehicles, etc.), air and terrestrial traffic control, radar astronomy, air-defense systems, anti-missile systems, marine radars to locate landmarks and other ships, aircraft anti-collision systems, ocean surveillance systems, outer space surveillance and rendezvous systems, meteorological precipitation monitoring, altimetry and flight control systems, guided missile target locating systems, ground-penetrating radar for geological observations, and so on. Furthermore, other embodiments may be more generally implemented in any artificial intelligence and/or machine learning-type environment. The following description discussed embodiments as implemented in an automotive environment, but one skilled in the art will appreciate that embodiments may be implemented in a variety of different environments and use cases. Further details of the MICU of embodiments herein are further described below with respect to FIGS. 1-6.

FIG. 1 is a block diagram of a detailed view of an example AV 100 providing a MICU to combine inertial data measurements coming from any number of inertial data sensors to provide a single inertial measurement, in accordance with embodiments herein. Although some embodiments herein are described as operating in an AV 100, other embodiments may be implemented in an environment that is not an AV, such as, for example, other types of vehicles (human operated, driver-assisted vehicles, etc.), air and terrestrial traffic control, radar astronomy, air-defense systems, anti-missile systems, marine radars to locate landmarks and other ships, aircraft anti-collision systems, ocean surveillance systems, outer space surveillance and rendezvous systems, meteorological precipitation monitoring, altimetry and flight control systems, guided missile target locating systems, ground-penetrating radar for geological observations, and so on. Furthermore, other embodiments may be more generally implemented in any artificial intelligence and/or machine learning-type environment.

In one embodiment, AV 100 can navigate about roadways without a human driver based on sensor signals generated by multiple sensor systems 104, 106, and 108. The sensor systems 104-108 can include different types of sensors and can be arranged about the AV 100. For instance, the sensor systems 104-108 can comprise IMUS, CMMs, ISMs, wheel speed (E.G., HRWEs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

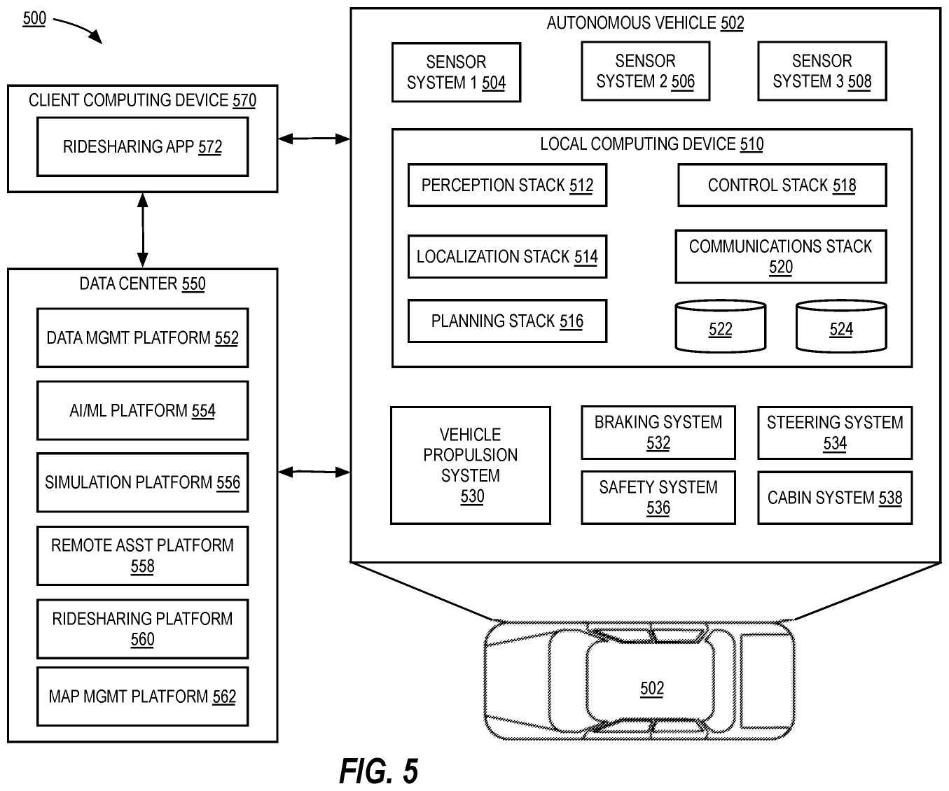

AV 100 can also include several mechanical systems (not shown) that can be used to maneuver or operate AV 100. For instance, the mechanical systems can include vehicle propulsion system, braking system, steering system, safety system, and cabin system, among other systems. The mechanical systems are described in further detail below with respect to FIG. 5.

AV 100 can additionally include a local computing device 110 that is in communication with the sensor systems 104-108, and the mechanical systems. In some embodiments, the local computing device 110 may also be in communication with a data center (not shown) and one or more other client computing devices (not shown), among other systems. The local computing device 110 can include one or more processors and memory, including instructions that can be executed by the one or more processors. The instructions can make up one or more software stacks or components responsible for controlling the AV 100; communicating with the data center, the client computing device(s), and other systems; receiving inputs from riders, passengers, and other entities within the AV's environment; logging metrics collected by the sensor systems 104-108; and so forth.

In this example, the local computing device 110 may also include an AV stack 115. The AV stack 115 can include components and processes to enable and support decision making in the AV operations in terms of routing, planning, sensing, maneuvering, operating, and so on. The AV stack 115 can include, among other stacks and systems, a perception stack 112, a localization stack 114, a planning stack 116, a control stack 118, a communications stack 120, a High Definition (HD) geospatial database 122, and an AV operational database 124, for example. Further details of the components of AV stack 115 may be found, for example, in the discussion of FIG. 5.

In embodiments herein, AV stack 115 may also include a MICU 130. As previously discussed, as redundancy of inertial data sensors in the AV 100 is introduced to the AV 100, the MICU 130 provides a versatile and resilient tool to combine the inertial data measurements coming from the multiple inertial data sensors to provide a single inertial data measurement. The MICU 130 functions as a ‘virtual IMU’ module, which runs upstream of inertial measurement data consumers (e.g., localization stack 114, perception stack 112, etc.) and can combine inertial sensor data coming from any number of inertial sensors to provide a single inertial measurement.

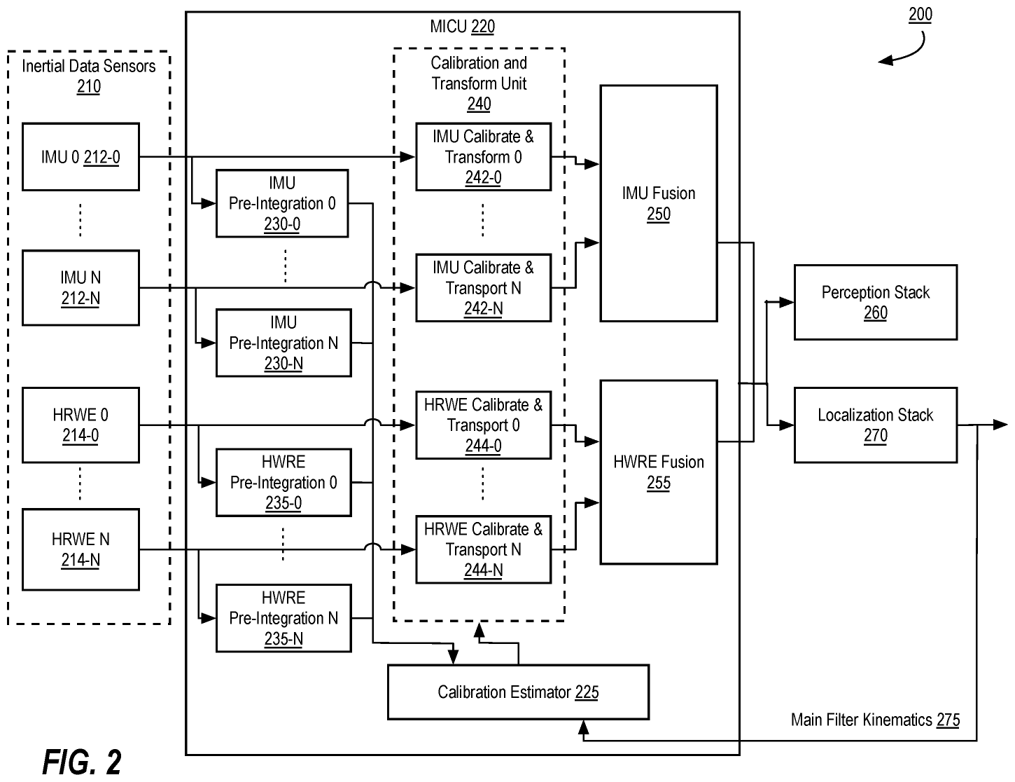

The MICU 130 of embodiments herein can simultaneously combine and calibrate any number of inertial data sensors upstream of its consumers, making consumers agnostic of which sensor the data came from in the event of sensor faults or temporary outages, reducing the severity of the degraded state of a single sensor outage. The MICU 130 is also capable of correcting for sensor biases, sensor mounting errors, and time-sync offsets between sensors and is easily extendable to combine as many inertial sensors as we decide to use. As a result, consumers can be inertial data sensor failure agnostic as all of the combinatorial and estimator logic is encapsulated in the MICU 130. Furthermore, in embodiments herein, the MICU 130 can receive feedback kinematics to calibrate each of the inertial data sensors that are in the constellation of sensors associated with the MICU 130. As such, the MICU 130 can calibrate both the biases as well as the extrinsic calibrations. Further details of operation of the MICU 130 and its operations are described with respect to FIGS. 2-6 below.

FIG. 2 illustrates a computing system 200 of an AV that provides a MICU to combine inertial data measurements coming from any number of inertial data sensors to provide a single inertial measurement, in accordance with embodiments herein. In one embodiment, computing system 200 may be the same as local computing device 110 of AV 100 described with respect to FIG. 1.

In one embodiment, computing system 200 implements a MICU 220 to combine inertial data measurements coming from multiple inertial data sensors into a single inertial measurement. The computing system 200 of the AV may include multiple inertial data sensors 210. Inertial data sensors 210 may include various redundant inertial data sensors of different types, such as IMUs, HRWEs, etc. For example, as shown in FIG. 2, inertial data sensors 210 may include two or more redundant IMUs shown as IMU 0 212-0 through IMU N 212-N (collectively referred to herein as IMUs 212). Inertial data sensors 210 may also include HRWEs shown as HRWE 0 214-0 through HRWE N 214-N (collectively referred to herein as HRWEs 214). Although not specifically illustrated, other inertial data sensor types may also be included as part of inertial data sensors 210 and the implementation of inertial data sensors 210 in the AV is not solely limited to the described components herein.

In one embodiment, inertial data measurements from the inertial data sensors 210 are passed to MICU 220. In one embodiment, MICU 220 is the same as MICU 130 described with respect to FIG. 1. The MICO 220 includes pre-integration modules for each inertial sensor, including IMU pre-integration 0 230-0 through IMU pre-integration N 230-N (collectively referred to herein as IMU pre-integration 230) and HRWE pre-integration 0 235-0 through HRWE pre-integration N 235-N (collectively referred to herein as HRWE pre-integration 235). MICU also includes a calibration and transform unit 240, fusion units (IMU fusion 250 and HRWE fusion 255), and a calibration estimator 225.

In embodiments herein, MICU 220 can be configured to perform as a virtual IMU pipeline or can be configured to perform as an augmented state module. In one embodiment, when the MICU 220 is configured with calibrations turned on, each inertial sensor (e.g., IMUs 212 or HRWEs 214) can be calibrated at calibration and transform unit 240. Calibration and transform unit 240 may include a calibration and transform module for each inertial data sensor 210, shown as IMU calibrate and transform 0 242-0 through IMU calibrate and transform N 242-N and HRWE calibrate and transform 0 244-0 through HRWE calibrate and transform N 244-N.

The calibrate and transform units 240 can receive a calibration signal from calibration estimator 225. The calibration estimator 225 can generate the calibration signal using main filter kinematics 275 as a feedback signal. Instead of the MICU 220 maintaining N global inertial estimates and propagating each with its inertial data sensors 210, embodiments herein leverage pre-integration methods to provide kinematic feedback as a pre-integrated measurement update from each pre-integration unit 230, 235. The pre-integration units 230, 235 for each inertial data sensor 210 can generate a pre-integrated measurement update. This pre-integrated measurement update is performed by each inertial data sensor pre-integration unit 230, 235 in isolation using the data that it has available to it. The pre-integrated measurement update is passed to the calibration estimator 225, which can compare the pre-integrated measurement update with the expected relative kinematic data from the main filter kinematics 275 for the same period. As a result, the MICU 220 does not maintain “global” states in the filter.

As noted above, the main filter kinematics 275 estimated by the main filter are an input to the calibration estimator 225 and, as such, are not directly modified by the multiple inertial data sensor 210 states. Therefore, if one or more inertial data sensor 210 calibration estimates become corrupted for any reason, the localization estimate is not degraded directly.

In embodiments herein, the calibrated and transformed inertial data sensor measurements are passed to fusion modules for each inertial data sensor 210, such as IMU fusion 250 and HRWE fusion 255. In one embodiment, the fusion modules 250, 255 can perform a fusion operation including, but not limited to, ordinary least squares, arithmetic average, weighted average, and so on. In some embodiments, the fusion operation is polynomial fitting, for example using iterative least squares. The result of the fusion operation is provided to one or more consumers as a single inertial data measurement for the particular type of inertial data sensor 210 (E.g., IMUs 212, HRWEs 214, etc.). In one embodiment, the consumers may include one or more stacks of the AV, such as the perception stack 260, the localization stack 270, and so on.

In one embodiment, the MICU 220 provides tuning parameters for the polynomial fitting to control smoothing and fit. For example, the tuning parameters may enable the polynomial fitting to be tuned for the length of the window used to fit the polynomial (e.g., 0.1 [s], 0.02 [s], 0.05 [s], . . . ) and the degree of the polynomial trying to be fit. In some embodiments, these two tuning parameters are correlated. For example, if a larger window of data is configured and a fit of a medium degree polynomial (e.g., 0.1 [s], with 5th degree polynomial) is configured, a smoother fit may result than if a small degree polynomial for a short window (e.g., 0.01 [s], 2nd degree polynomial) is fit.

In some embodiment, the MICU 220 can smooth some of the high-frequency noise while tracking the true dynamics sensed by each inertial data sensor 210 with high precision. For example, a robust iterative least squares can be implemented to fit the polynomial so that outliers are discarded. As such, if an inertial data sensor 210 (such as an IMU 212) consistently provides estimates that do not agree with the best polynomial fit, the sensor 210 can be tagged as faulty, a fault alarm can be set, and the remaining inertial data sensors 210 (of the sensor type) can continue to operate nominally.

In some embodiments, the MICU 220 can be configured to turn off calibrations. In this case, the fusion unit 250, 255 can utilize the polynomial fitting to mitigate any time-synch issues. Furthermore, the MICU 220 can utilize the latest calibration estimates as known values to provide inertial estimates that have already been calibrated and do not change as the constellation of inertial data sensors 210 changes (i.e., if an IMU is dropped, new biases for the MICU 220 output do not need to be estimated).

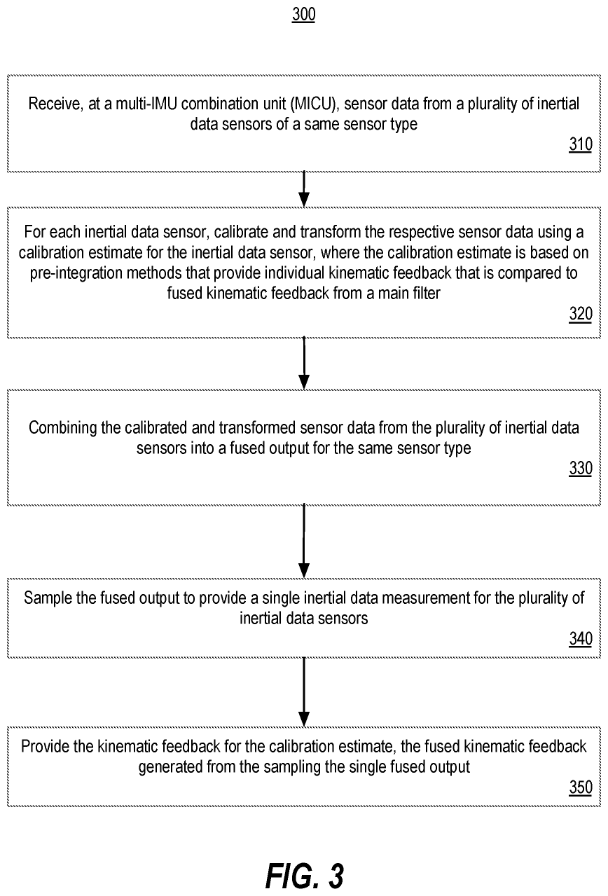

FIG. 3 illustrates an example method 300 implementing a MICU for generating a single inertial measurement for multiple inertial measurement data sensors, in accordance with embodiments herein. Although the example method 300 depicts a particular sequence of operations, the sequence may be altered without departing from the scope of the disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some embodiments, the method 300 includes block 310 where a MICU component receives sensor data from a plurality of inertial data sensors of a same sensor type. In one embodiment, the MICO is operating in an AV. In one embodiment, the inertial data sensors can include sensor types such as IMUs, CCMs, ISMs, HRWS, and so on. Then, at block 320, for each inertial data sensor, the respective sensor data is calibrated and transformed using a calibration estimate for the inertial data sensor. In one embodiment, the calibration estimate is based on pre-integration methods that provide kinematic feedback that is compared to kinematic feedback from a main filter. In one embodiment, the main filter is a localization stack of the AV.

Subsequently, at block 330, the calibrated and transformed sensor data from the plurality of inertial data sensors is fused into a fused output for the sensor type. In one embodiment, the fusion can include fitting an N-degree polynomial to the calibrated and transformed sensor data. Then, at block 340, the fused output is sampled to provide a single inertial data measurement for the plurality of inertial data sensors. Lastly, at block 350, the kinematic feedback for the calibration estimate is provided back to the MICU. In one embodiment, the kinematic feedback is generated from the sampling the single fused output.

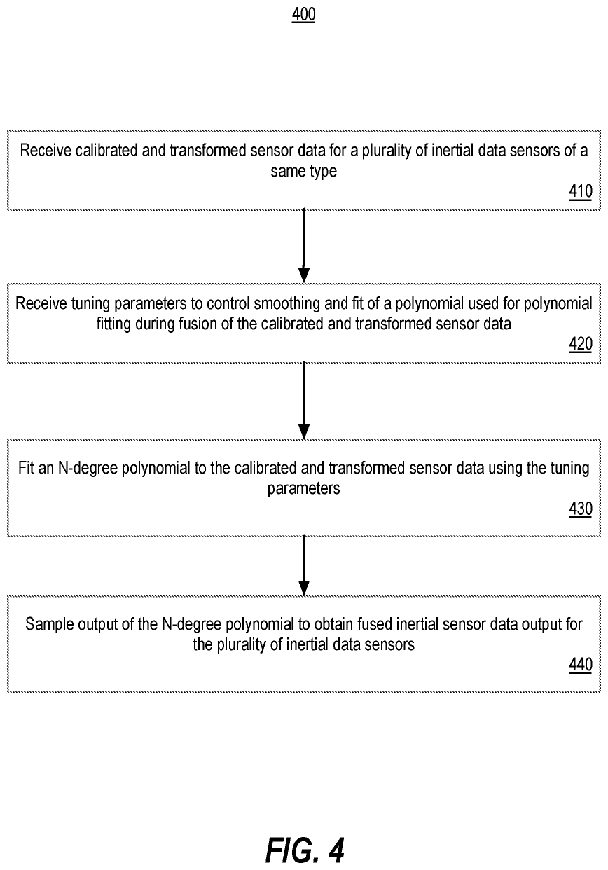

FIG. 4 illustrates an example method 400 implementing a MICU performing polynomial fitting as part of a fusion operation, in accordance with embodiments herein. Although the example method 400 depicts a particular sequence of operations, the sequence may be altered without departing from the scope of the disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some embodiments, the method 400 includes block 410 where calibrated and transformed sensor data is received from a plurality of inertial data sensors of a same type. In one embodiment, the inertial data sensors are part of an AV and can include sensor types such as IMUs, CCMs, ISMs, HRWS, and so on. Then, at block 420, tuning parameters are received to control smoothing and fit of a polynomial used for polynomial fitting during fusion of the calibrated and transformed sensor data.

Subsequently, at block 430, an N-degree polynomial is fit to the calibrated and transformed sensor data using the tuning parameters. Lastly, at block 440, output of the N-degree polynomial is sampled to obtain fused inertial sensor data output for the plurality of inertial data sensors.

Turning now to FIG. 5, this figure illustrates an example of an AV management system 500. In one embodiment, the AV management system 500 can implement a MICU as described herein. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 500 includes an AV 502, a data center 550, and a client computing device 570. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 502 can navigate about roadways without a human driver based on sensor signals generated by multiple sensor systems 504, 506, and 508. The sensor systems 504-508 can include different types of sensors and can be arranged about the AV 502. For instance, the sensor systems 504-508 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other embodiments may include any other number and type of sensors.

AV 502 can also include several mechanical systems that can be used to maneuver or operate AV 502. For instance, the mechanical systems can include vehicle propulsion system 530, braking system 532, steering system 534, safety system 536, and cabin system 538, among other systems. Vehicle propulsion system 530 can include an electric motor, an internal combustion engine, or both. The braking system 532 can include an engine brake, a wheel braking system (e.g., a disc braking system that utilizes brake pads), hydraulics, actuators, and/or any other suitable componentry configured to assist in decelerating AV 502. The steering system 534 can include suitable componentry configured to control the direction of movement of the AV 502 during navigation. Safety system 536 can include lights and signal indicators, a parking brake, airbags, and so forth. The cabin system 538 can include cabin temperature control systems, in-cabin entertainment systems, and so forth. In some embodiments, the AV 502 may not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

AV 502 can additionally include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a mapping and localization stack 514, a planning stack 516, a control stack 518, a communications stack 520, a High Definition (HD) geospatial database 522, and an AV operational database 524, among other stacks and systems.

Perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 522, other components of the AV, and other data sources (e.g., the data center 550, the client computing device 570, third-party data sources, etc.). The perception stack 512 can detect and classify objects and determine their current and predicted locations, speeds, directions, and the like. In addition, the perception stack 512 can determine the free space around the AV 502 (e.g., to maintain a safe distance from other objects, change lanes, park the AV, etc.). The perception stack 512 can also identify environmental uncertainties, such as where to look for moving objects, flag areas that may be obscured or blocked from view, and so forth.

Mapping and localization stack 514 can determine the AV's position and orientation (pose) using different methods from multiple systems (e.g., GPS, IMUs, cameras, LIDAR, RADAR, ultrasonic sensors, the HD geospatial database 522, etc.). For example, in some embodiments, the AV 502 can compare sensor data captured in real-time by the sensor systems 504-508 to data in the HD geospatial database 522 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

The planning stack 516 can determine how to maneuver or operate the AV 502 safely and efficiently in its environment. For example, the planning stack 516 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 502 from one point to another. The planning stack 516 can determine multiple sets of one or more mechanical operations that the AV 502 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 516 can select from multiple backup plans to carry out. For example, while preparing to change lanes to turn right at an intersection, another vehicle may aggressively cut into the destination lane, making the lane change unsafe. The planning stack 516 could have already determined an alternative plan for such an event, and upon its occurrence, help to direct the AV 502 to go around the block instead of blocking a current lane while waiting for an opening to change lanes.

The control stack 518 can manage the operation of the vehicle propulsion system 530, the braking system 532, the steering system 534, the safety system 536, and the cabin system 538. The control stack 518 can receive sensor signals from the sensor systems 504-508 as well as communicate with other stacks or components of the local computing device 510 or a remote system (e.g., the data center 550) to effectuate operation of the AV 502. For example, the control stack 518 can implement the final path or actions from the multiple paths or actions provided by the planning stack 516. This can involve turning the routes and decisions from the planning stack 516 into commands for the actuators that control the AV's steering, throttle, brake, and drive unit.

The communication stack 520 can transmit and receive signals between the various stacks and other components of the AV 502 and between the AV 502, the data center 550, the client computing device 570, and other remote systems. The communication stack 520 can enable the local computing device 510 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 520 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 522 can store HD maps and related data of the streets upon which the AV 502 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

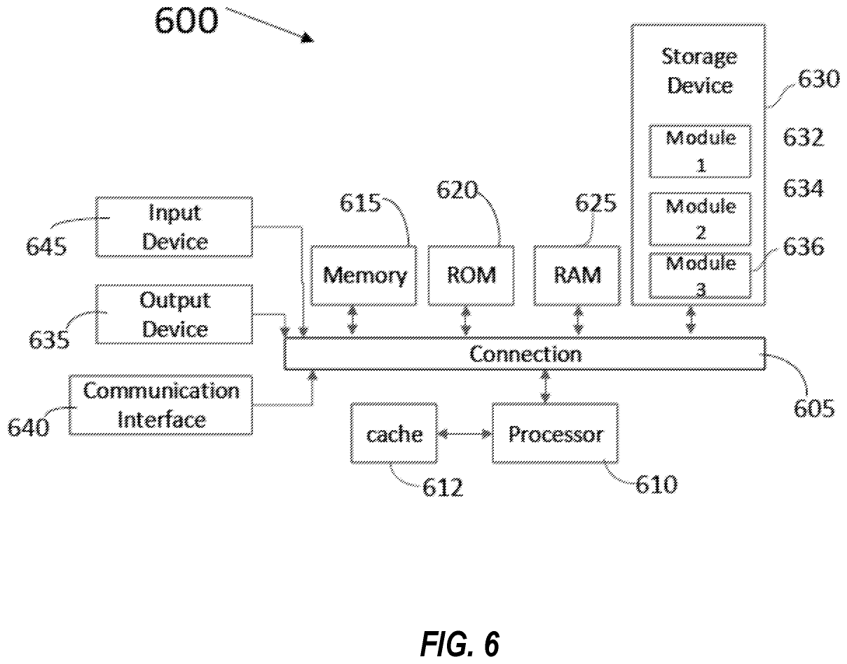

The AV operational database 524 can store raw AV data generated by the sensor systems 504-508 and other components of the AV 502 and/or data received by the AV 502 from remote systems (e.g., the data center 550, the client computing device 570, etc.). In some embodiments, the raw AV data can include HD LIDAR point cloud data, image or video data, RADAR data, GPS data, and other sensor data that the data center 550 can use for creating or updating AV geospatial data as discussed further below with respect to FIG. 6 and elsewhere in the disclosure.

The data center 550 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 550 can include one or more computing devices remote to the local computing device 510 for managing a fleet of AVs and AV-related services. For example, in addition to managing the AV 502, the data center 550 may also support a ridesharing service, a delivery service, a remote/roadside assistance service, street services (e.g., street mapping, street patrol, street cleaning, street metering, parking reservation, etc.), and the like.

The data center 550 can send and receive various signals to and from the AV 502 and the client computing device 570. These signals can include sensor data captured by the sensor systems 504-508, roadside assistance requests, software updates, ridesharing pick-up and drop-off instructions, and so forth. In this example, the data center 550 includes one or more of a data management platform 552, an Artificial Intelligence/Machine Learning (AI/ML) platform 554, a simulation platform 556, a remote assistance platform 558, a ridesharing platform 560, and a map management platform 562, among other systems.

Data management platform 552 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ridesharing platform 560, the map management platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 502, the remote assistance platform 558, the ridesharing platform 560, the map management platform 562, and other platforms and systems. The simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from the map management platform 562; modeling the behavior of other vehicles, bicycles, pedestrians, and other dynamic elements; simulating inclement weather conditions, different traffic scenarios; and so on.

The remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

The ridesharing platform 560 can interact with a customer of a ridesharing service via a ridesharing application 572 executing on the client computing device 570. The client computing device 570 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 572. The client computing device 570 can be a customer's mobile computing device or a computing device integrated with the AV 502 (e.g., the local computing device 510). The ridesharing platform 560 can receive requests to be picked up or dropped off from the ridesharing application 572 and dispatch the AV 502 for the trip.

Map management platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, Unmanned Aerial Vehicles (UAVs), satellites, third-party mapping services, and other sources of geospatially referenced data. The raw data can be processed, and map management platform 562 can render base representations (e.g., tiles (2D), bounding volumes (3D), etc.) of the AV geospatial data to enable users to view, query, label, edit, and otherwise interact with the data. Map management platform 562 can manage workflows and tasks for operating on the AV geospatial data. Map management platform 562 can control access to the AV geospatial data, including granting or limiting access to the AV geospatial data based on user-based, role-based, group-based, task-based, and other attribute-based access control mechanisms. Map management platform 562 can provide version control for the AV geospatial data, such as to track specific changes that (human or machine) map editors have made to the data and to revert changes when necessary. Map management platform 562 can administer release management of the AV geospatial data, including distributing suitable iterations of the data to different users, computing devices, AVs, and other consumers of HD maps. Map management platform 562 can provide analytics regarding the AV geospatial data and related data, such as to generate insights relating to the throughput and quality of mapping tasks.

In some embodiments, the map viewing services of map management platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 502 in transit en route to a pick-up or drop-off location, and so on.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with hardware components, such as processor 610, connection 605, output device 635, etc., to carry out the function.

Embodiments within the scope of the disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Example 1 includes a method for facilitating a multi-IMU combination unit (MICU), where the method comprises: receiving, at a MICU executed by a processing device, sensor data from a plurality of inertial data sensors of a same sensor type; for each inertial data sensor, calibrating and transforming the respective sensor data using a calibration estimate for the inertial data sensor, where the calibration estimate is based on pre-integration methods that provide individual kinematic feedback that is compared to fused kinematic feedback from a main filter; combining the calibrated and transformed sensor data from the plurality of inertial data sensors into a fused output for the same sensor type; sampling the fused output to provide a single inertial data measurement for the plurality of inertial data sensors; and providing the fused kinematic feedback for the calibration estimate, the fused kinematic feedback generated from the sampling of the single fused output.

In Example 2, the subject matter of Example 1 can optionally include wherein the MICU is hosted by an autonomous vehicle (AV) comprising the plurality of inertial data sensors. In Example 3, the subject matter of any one of Examples 1-2 can optionally include wherein the inertial data sensors comprise one or more of an inertial measurement unit (IMU), a coordinate measuring machine (CMM), or a high-resolution wheel encoder (HRWE). In Example 4, the subject matter of any one of Examples 1-3 can optionally include wherein combining the calibrated and transformed sensor data further comprises fitting an N-degree polynomial using the calibrated and transformed sensor data.

In Example 5, the subject matter of any one of Examples 1-4 can optionally include wherein the N-degree polynomial is fitted using tuning parameters to control smoothing and fit of the N-degree polynomial, and wherein the tuning parameters are for at least one of a length of time window of the sensor data or a degree of the N-degree polynomial. In Example 6, the subject matter of any one of Examples 1-5 can optionally include further comprising tagging at least one of the inertial data sensors as a faulty inertial data sensor responsive to the faulty inertial data sensor generating estimates that trigger a fault condition indicating that the estimates do not agree with the fit of the N-degree polynomial.

In Example 7, the subject matter of any one of Examples 1-6 can optionally include wherein the faulty inertial data sensor is removed from operation and remaining inertial data sensors of the plurality of inertial data sensors continue to operate. In Example 8, the subject matter of any one of Examples 1-7 can optionally include wherein a tunable parameter of the MICU enables the fused kinematic feedback to be turned on or off for purposes of generating the calibration estimate. In Example 9, the subject matter of any one of Examples 1-8 can optionally include wherein a consumer of the fused output comprises a localization stack of an autonomous vehicle (AV).

Example 10 includes an apparatus for facilitating a MICU, the apparatus of Example 10 comprising one or more hardware processors to: receive, at a multi-IMU combination unit (MICU) executed by the one or more hardware processors, sensor data from a plurality of inertial data sensors of a same sensor type; for each inertial data sensor, calibrate and transform the respective sensor data using a calibration estimate for the inertial data sensor, where the calibration estimate is based on pre-integration methods that provide individual kinematic feedback that is compared to fused kinematic feedback from a main filter; combine the calibrated and transformed sensor data from the plurality of inertial data sensors into a fused output for the same sensor type; sample the fused output to provide a single inertial data measurement for the plurality of inertial data sensors; and provide the fused kinematic feedback for the calibration estimate, the fused kinematic feedback generated from the sampling of the single fused output.

In Example 11, the subject matter of Example 10 can optionally include wherein the MICU is hosted by an autonomous vehicle (AV) comprising the plurality of inertial data sensors, and wherein the inertial data sensors comprise one or more of an inertial measurement unit (IMU), a coordinate measuring machine (CMM), or a high-resolution wheel encoder (HRWE). In Example 12, the subject matter of Examples 10-11 can optionally include wherein the one or more hardware processors to combine the calibrated and transformed sensor data further comprises the one or more hardware processors to fit an N-degree polynomial using the calibrated and transformed sensor data.

In Example 13, the subject matter of Examples 10-12 can optionally include wherein the N-degree polynomial is fitted using tuning parameters to control smoothing and fit of the N-degree polynomial, and wherein the tuning parameters are for at least one of a length of time window of the sensor data or a degree of the N-degree polynomial. In Example 14, the subject matter of Examples 10-13 can optionally include wherein the one or more hardware processors are further to tag at least one of the inertial data sensors as a faulty inertial data sensor responsive to the faulty inertial data sensor generating estimates that trigger a fault condition indicating that the estimates do not agree with the fit of the N-degree polynomial. In Example 15, the subject matter of Examples 10-14 can optionally include wherein the faulty inertial data sensor is removed from operation and remaining inertial data sensors of the plurality of inertial data sensors continue to operate.

Example 16 is a non-transitory computer-readable storage medium for facilitating a MICU. The non-transitory computer-readable storage medium of Example 16 having stored thereon executable computer program instructions that, when executed by one or more processors, cause the one or more processors to: receive, at a multi-IMU combination unit (MICU) executed by the one or more processors, sensor data from a plurality of inertial data sensors of a same sensor type; for each inertial data sensor, calibrate and transform the respective sensor data using a calibration estimate for the inertial data sensor, where the calibration estimate is based on pre-integration methods that provide individual kinematic feedback that is compared to fused kinematic feedback from a main filter; combine the calibrated and transformed sensor data from the plurality of inertial data sensors into a fused output for the same sensor type; sample the fused output to provide a single inertial data measurement for the plurality of inertial data sensors; and provide the fused kinematic feedback for the calibration estimate, the fused kinematic feedback generated from the sampling of the single fused output.

In Example 17, the subject matter of Example 16 can optionally include wherein the MICU is hosted by an autonomous vehicle (AV) comprising the plurality of inertial data sensors, and wherein the inertial data sensors comprise one or more of an inertial measurement unit (IMU), a coordinate measuring machine (CMM), or a high-resolution wheel encoder (HRWE). In Example 18, the subject matter of Examples 16-17 can optionally include wherein the one or more processors to combine the calibrated and transformed sensor data further comprises the one or more processors to fit an N-degree polynomial using the calibrated and transformed sensor data.

In Example 19, the subject matter of Examples 16-18 can optionally include wherein the N-degree polynomial is fitted using tuning parameters to control smoothing and fit of the N-degree polynomial, and wherein the tuning parameters are for at least one of a length of time window of the sensor data or a degree of the N-degree polynomial. In Example 20, the subject matter of Examples 16-19 can optionally include wherein the one or more processors are further to tag at least one of the inertial data sensors as a faulty inertial data sensor responsive to the faulty inertial data sensor generating estimates that trigger a fault condition indicating that the estimates do not agree with the fit of the N-degree polynomial.

Example 21 is a system for facilitating a MICU. The system of Example 21 can optionally include a memory to store a block of data, and one or more hardware processors to: receive, at a multi-IMU combination unit (MICU) executed by the one or more hardware processors, sensor data from a plurality of inertial data sensors of a same sensor type; for each inertial data sensor, calibrate and transform the respective sensor data using a calibration estimate for the inertial data sensor, where the calibration estimate is based on pre-integration methods that provide individual kinematic feedback that is compared to fused kinematic feedback from a main filter; combine the calibrated and transformed sensor data from the plurality of inertial data sensors into a fused output for the same sensor type; sample the fused output to provide a single inertial data measurement for the plurality of inertial data sensors; and provide the fused kinematic feedback for the calibration estimate, the fused kinematic feedback generated from the sampling of the single fused output.

In Example 22, the subject matter of Example 21 can optionally include wherein the MICU is hosted by an autonomous vehicle (AV) comprising the plurality of inertial data sensors, and wherein the inertial data sensors comprise one or more of an inertial measurement unit (IMU), a coordinate measuring machine (CMM), or a high-resolution wheel encoder (HRWE). In Example 23, the subject matter of Examples 21-22 can optionally include wherein the one or more hardware processors to combine the calibrated and transformed sensor data further comprises the one or more hardware processors to fit an N-degree polynomial using the calibrated and transformed sensor data.

In Example 24, the subject matter of Examples 21-23 can optionally include wherein the N-degree polynomial is fitted using tuning parameters to control smoothing and fit of the N-degree polynomial, and wherein the tuning parameters are for at least one of a length of time window of the sensor data or a degree of the N-degree polynomial. In Example 25, the subject matter of Examples 21-24 can optionally include wherein the one or more hardware processors are further to tag at least one of the inertial data sensors as a faulty inertial data sensor responsive to the faulty inertial data sensor generating estimates that trigger a fault condition indicating that the estimates do not agree with the fit of the N-degree polynomial. In Example 26, the subject matter of Examples 21-25 can optionally include wherein the faulty inertial data sensor is removed from operation and remaining inertial data sensors of the plurality of inertial data sensors continue to operate.

Example 27 includes an apparatus comprising means for performing the method of any of the Examples 1-9. Example 28 is at least one machine readable medium comprising a plurality of instructions that in response to being executed on a computing device, cause the computing device to carry out a method according to any one of Examples 1-9. Example 29 is an apparatus for facilitating a MICU, configured to perform the method of any one of Examples 1-9. Specifics in the Examples may be used anywhere in one or more embodiments.

The various embodiments described above are provided by way of illustration and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A method comprising:
receiving, at a multi-IMU combination unit (MICU) executed by a processing device, sensor data from a plurality of inertial data sensors of a same sensor type;
for each inertial data sensor, calibrating and transforming the respective sensor data using a calibration estimate for the inertial data sensor, where the calibration estimate is based on pre-integration methods that provide individual kinematic feedback that is compared to fused kinematic feedback from a main filter;
combining the calibrated and transformed sensor data from the plurality of inertial data sensors into a fused output for the same sensor type;
sampling the fused output to provide a single inertial data measurement for the plurality of inertial data sensors; and
providing the fused kinematic feedback for the calibration estimate, the fused kinematic feedback generated from the sampling of the single fused output.

2. The method of claim 1, wherein the MICU is hosted by an autonomous vehicle (AV) comprising the plurality of inertial data sensors.

3. The method of claim 1, wherein the inertial data sensors comprise one or more of an inertial measurement unit (IMU), a coordinate measuring machine (CMM), or a high-resolution wheel encoder (HRWE).

4. The method of claim 1, wherein combining the calibrated and transformed sensor data further comprises fitting an N-degree polynomial using the calibrated and transformed sensor data.

5. The method of claim 4, wherein the N-degree polynomial is fitted using tuning parameters to control smoothing and fit of the N-degree polynomial, and wherein the tuning parameters are for at least one of a length of time window of the sensor data or a degree of the N-degree polynomial.

6. The method of claim 4, further comprising tagging at least one of the inertial data sensors as a faulty inertial data sensor responsive to the faulty inertial data sensor generating estimates that trigger a fault condition indicating that the estimates do not agree with the fit of the N-degree polynomial.

7. The method of claim 6, wherein the faulty inertial data sensor is removed from operation and remaining inertial data sensors of the plurality of inertial data sensors continue to operate.

8. The method of claim 1, wherein a tunable parameter of the MICU enables the fused kinematic feedback to be turned on or off for purposes of generating the calibration estimate.

9. The method of claim 1, wherein a consumer of the fused output comprises a localization stack of an autonomous vehicle (AV).

10. An apparatus comprising:
one or more hardware processors to:
receive, at a multi-IMU combination unit (MICU) executed by the one or more hardware processors, sensor data from a plurality of inertial data sensors of a same sensor type;
for each inertial data sensor, calibrate and transform the respective sensor data using a calibration estimate for the inertial data sensor, where the calibration estimate is based on pre-integration methods that provide individual kinematic feedback that is compared to fused kinematic feedback from a main filter;
combine the calibrated and transformed sensor data from the plurality of inertial data sensors into a fused output for the same sensor type;
sample the fused output to provide a single inertial data measurement for the plurality of inertial data sensors; and
provide the fused kinematic feedback for the calibration estimate, the fused kinematic feedback generated from the sampling of the single fused output.

11. The apparatus of claim 10, wherein the MICU is hosted by an autonomous vehicle (AV) comprising the plurality of inertial data sensors, and wherein the inertial data sensors comprise one or more of an inertial measurement unit (IMU), a coordinate measuring machine (CMM), or a high-resolution wheel encoder (HRWE).

12. The apparatus of claim 10, wherein the one or more hardware processors to combine the calibrated and transformed sensor data further comprises the one or more hardware processors to fit an N-degree polynomial using the calibrated and transformed sensor data.

13. The apparatus of claim 12, wherein the N-degree polynomial is fitted using tuning parameters to control smoothing and fit of the N-degree polynomial, and wherein the tuning parameters are for at least one of a length of time window of the sensor data or a degree of the N-degree polynomial.

14. The apparatus of claim 12, wherein the one or more hardware processors are further to tag at least one of the inertial data sensors as a faulty inertial data sensor responsive to the faulty inertial data sensor generating estimates that trigger a fault condition indicating that the estimates do not agree with the fit of the N-degree polynomial.

15. The apparatus of claim 14, wherein the faulty inertial data sensor is removed from operation and remaining inertial data sensors of the plurality of inertial data sensors continue to operate.

16. A non-transitory computer-readable medium having stored thereon instructions that, when executed by one or more processors, cause the one or more processors to:
receive, at a multi-IMU combination unit (MICU) executed by the one or more processors, sensor data from a plurality of inertial data sensors of a same sensor type;
for each inertial data sensor, calibrate and transform the respective sensor data using a calibration estimate for the inertial data sensor, where the calibration estimate is based on pre-integration methods that provide individual kinematic feedback that is compared to fused kinematic feedback from a main filter;
combine the calibrated and transformed sensor data from the plurality of inertial data sensors into a fused output for the same sensor type;
sample the fused output to provide a single inertial data measurement for the plurality of inertial data sensors; and
provide the fused kinematic feedback for the calibration estimate, the fused kinematic feedback generated from the sampling of the single fused output.

17. The non-transitory computer-readable medium of claim 16, wherein the MICU is hosted by an autonomous vehicle (AV) comprising the plurality of inertial data sensors, and wherein the inertial data sensors comprise one or more of an inertial measurement unit (IMU), a coordinate measuring machine (CMM), or a high-resolution wheel encoder (HRWE).

18. The non-transitory computer-readable medium of claim 16, wherein the one or more processors to combine the calibrated and transformed sensor data further comprises the one or more processors to fit an N-degree polynomial using the calibrated and transformed sensor data.

19. The non-transitory computer-readable medium of claim 18, wherein the N-degree polynomial is fitted using tuning parameters to control smoothing and fit of the N-degree polynomial, and wherein the tuning parameters are for at least one of a length of time window of the sensor data or a degree of the N-degree polynomial.

20. The non-transitory computer-readable medium of claim 18, wherein the one or more processors are further to tag at least one of the inertial data sensors as a faulty inertial data sensor responsive to the faulty inertial data sensor generating estimates that trigger a fault condition indicating that the estimates do not agree with the fit of the N-degree polynomial.
